(19) United States
(12) Patent Application Publication
(10) Pub. No.: US 2004/0225146 A1
(43) Pub. Date: Nov. 11, 2004

(54) Tyrosine phosphatase scafold synthesis

(76) Inventors: Hartmuth C. Kolb, San Diego, CA (US); Paul F. Richardson, Monmouth Junction, NJ (US); Ramanaiah C. Kanamarlapudi, Bridgewater, NJ (US)

Correspondence Address: McDonnell Boehnen Hulbert & Berghoff, 32nd Floor, 300 S. Wacker Drive, Chicago, IL, 60606, US

(21) Appl. No.: 10/429,301

(22) Filed: May 5, 2003

(51) Int. Cl. C07F 9/28

(52) U.S. Cl. 562/24; 558/194

(57) ABSTRACT

Disclosed are 4-(difluoromethylene)phosphonate cinnamic acid derivatives as a molecular scaffold for the preparation of protein tyrosine phosphatase inhibitors. The invention also relates to a process for the combinatorial preparation of protein tyrosine phospatase inhibitors possessing a 4-(difluoromethylene)phosphonate cinnamic acid/ester molecular scaffold.

### BACKGROUND OF THE INVENTION

1. Field of the Invention

This invention relates to 4-(difluoromethylene)phosphonate cinnamic acid derivatives. The invention also relates to 4-(difluoromethylene)phosphonate cinnamic acid derivatives that serve as a potential molecular scaffold for the preparation of protein tyrosine phosphatase inhibitors in a combinatorial fashion. The invention further relates to a process for the large scale synthesis of these protein tyrosine phosphatase inhibitors possessing a 4-(difluoromethylene)phosphonate cinnamic acid/ester molecular scaffold.

2. Description of the Related Art

Protein tyrosine phosphatases (PTPs) are enzymes that catalyze the removal of phosphate groups from phosphotyrosine residues in proteins. These enzymes are crucial for the regulation of a wide variety of biochemical processes such as intracellular signaling, cell growth and differentiation (Sun, H., Tonks, N. K. Trends in Biochem. Sci. 1994, 19, 480; Tonks, N. K. Adv. Pharmacol. 1996, 36, 91; Ide, R., Maegawa, H., Kikkawa, R., Shigetta, Y., Kashiwagi, A. Biochem. Biophys. Res. Commun. 1994, 201, 77; Weiner, J. r, Hurteau, J. A., Kems, B. J., Whitaker, R. S., Conaway, M. R., Berchuck, A., Bast, R. C., Am. J. Obstet. Gynecol., 1994, 170, 1171). As such, there is a lot of research focused on identifying inhibitors for these enzymes (Ripka, W. C., Annual Reports in Medicinal Chemistry, 2000, 35, 231; Brugge, J. S., Science, 1993, 260, 918; Kole, K. H., Smyth, M. S., Russ, P. L., Burke, T. R. Biochem. J. 1995, 311, 1025 and references therein). In particular, there is currently considerable interest in (difluoromethylene)phosphonates as hydrolytically stable analogues of naturally occurring phosphate esters (such as PTPs), since they accurately mimic the parental phosphates in their isoteric and isopolar properties (Blackburn, G. M. Chem. Ind. 1981, 134; Blackburn, G. M., Kent, D. E., Kolkmann, F. J. Chem. Soc. Perkin Trans. I., 1984, 1119). Although the concept of (difluoromethylene)phosphonates as analogues of phosphate esters has been extensively argued (Thatcher, G. R. J., Campbell, A. S. J. Org. Chem., 1193, 58, 2272; Nieschalk, J, O'Hagan, D. J., J. Chem. Soc. Chem. Commun., 1995, 719; Nieschalk, J., Batsunov, A. s., O'Hagan, D. J., Howard, J. A. K., Tetrahedron, 1996, 52,165), there are now numerous examples in which the substitution of phosphate groups in natural and unnatural products with (difluoromethylene)phosphonate moieties have resulted in a significant enhancement of biological properties (Martin, S. F., Wong, Y- L, Wagman, A. S., J. Org. Chem. 1994, 59, 4821; Matulic-Adamic, J., Hacberli, P., Usman, N., J. Org. Chem. 1995, 60, 2563; Chambers, R. D., Jaouhari, R, O'Hagan, D, J. Chem. Soc. Chem. Commun. 1988, 1169; Phillion, D. P., Cleary, D. G., J. Org. Chem., 1992, 57, 2763; Matulic-Adamic, J, Usman, N. Tetrahedron Lett., 1993, 35, 3227; Vinod, T. K., Griffith, O. H., Keana, J. F. W., Tetrahedron Lett., 1994, 35, 7193., Burke, T. R., Kole, H. K., Roller, P. P., Biochem. Biophys. Res. Commun. 1994, 204, 129; Kole, H. K., Akamatsu, M., Ye, B, Yan, X., Barford, D, Roller, P. P, Burke, T. R., Biochem. Biophys. Res. Commun. 1995, 209, 817; Chen, L., Wu, L., Otaka, A., Smyth, M. S., Roller, P. P., Burke, T. R., den Hertog, J., Zhang, Z -Y., Biochem. Biophys. Res. Commun. 1995, 216, 976).

### SUMMARY OF THE INVENTION

The present invention provides a novel protein tyrosine phosphatase inhibitor scaffold. The present invention also provides a process for the preparation of cinnamate ester derivatives containing a (difluoromethylene)phosphonate moiety. Specifically, the method of the present invention utilizes a Heck reaction and a cuprate/organozinc cross-coupling reaction to form the desired tyrosine phosphanate inhibitor scaffold.

### DETAILED DESCRIPTION OF THE INVENTION

The instant invention encompasses compounds of the Formula I as tyrosine phosphonate inhibitor scaffold.

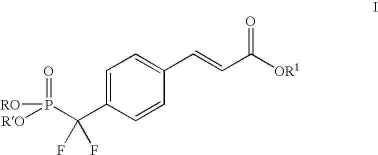

wherein

R¹ is hydrogen or lower alkyl; and

R and R′ are the same and represent hydrogen or a phosphate protecting group.

Preferably, R¹ is hydrogen or methyl.

By “alkyl”, “lower alkyl”, and “C₁-C₁₀ alkyl” in the present invention is meant straight or branched chain alkyl groups having 1-10 carbon atoms, such as, methyl, ethyl, propyl, isopropyl, n-butyl, sec-butyl, tert-butyl, pentyl, 2-pentyl, isopentyl, neopentyl, hexyl, 2-hexyl, 3-hexyl, and 3-methylpentyl. These groups may be substituted with up to four groups mentioned below for substituted aryl.

A “carbocyclic group” or “cycloalkyl” is a nonaromatic cyclic ring or fused rings having from 3 to 7 ring members. Examples include cyclopropyl, cyclobutyl, and cycloheptyl.

By “aryl” is meant an aromatic carbocyclic group having a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl), A preferred aryl is phenyl.

The present invention also encompasses a method for preparing compounds of Formula I. In one embodiment, and according to Scheme 1, a first step involves an optimized one-pot method for the large-scale preparation a 4-substituted cinnamate ester II via careful optimization of Heck reaction conditions (Heck, R. F., Org. React. 1982, 27, 345), wherein R₁ is lower alkyl. The reaction involved modifying the Genet (Brunner, H., Le Cousturier de Courcy, N., Genet, J -P., Tetrahedron Lett. 1999, 40, 4815) procedure under similar Sengupta-type conditions (Sengupta, S., Bhattacharyya, S., Tetrahedron Lett. 1995, 36, 4475; Sengupta, S., Bhattacharya, S., J. Chem. Soc. Perkin Trans I, 1993, 1943). Formation of the diazonium salt proceeds nicely and is followed by reaction with the acrylate under palladium catalysis in aqueous media to afford II in excellent yield. In the second step of Scheme 1, the 4-substituted cinnamate ester II is reacted with the desired [(4-Bromo-phenyl)-difluoro-methyl]-phosphonate to afford a compound of Formula I.

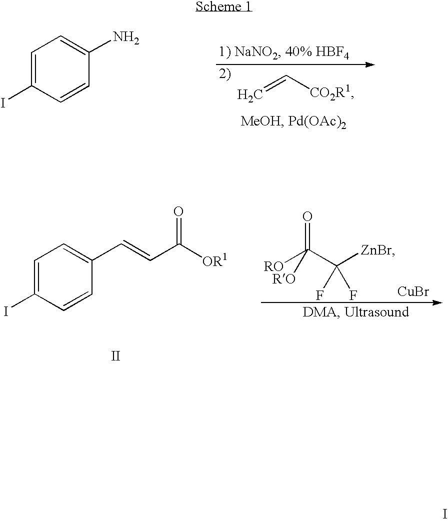

Examples of suitable solvents for the one-pot Heck reaction shown in scheme 1 include, but are not limited to, one or more of the following: a protic solvent such as methanol, ethanol, n-propanol, n-butanol or water; or aprotic solvents such as dimethylsulfoxide, dimethylformamide, hexamethylphosphorotriamide or toluene. In preferred embodiment, the solvent system is a protic solvent system such as water and/or methanol.

In a preferred embodiment, the nitrate and 4-iodoaniline of the one-pot Heck reaction in scheme 1 is carried out at temperatures between −25° C. and 25° C. More preferably, the reaction temperature is between −10° C. and 10° C. and even more preferably the reaction temperature is around −10° C. and 0° C. Upon addition of the acrylate and catalyst, the reaction is carried out at temperatures of from between 0° C. and 100° C. and preferably at about 25° C. and 75° C.

A wide variety of active palladium species can been utilized in the Heck reactions of the present invention. In general, the palladium is co-ordinated to a series of ligands. These ligands either form part of the pre-formed catalyst (c.f. tetrakis(triphenylphosphine) palladium) or are added to the reaction as a separate species. Accordingly, the palladium catalyst of the present invention is selected from palladium acetate, palladium chloride or tetrakis(triphenylphosphine)palladium. A preferred palladium catalyst is palladium acetate. Ligands for the Heck reaction include, but are not limited to, phosphine based ligands. Examples include triphenylphosphine, 1,3-bis(diphenylphosphino)propane (DPPP) and 1,1′-bis(diphenylphosphino)ferrocene (DPPF). A preferred catalyst/ligand species used for the current invention is a pre-formed oxime palladacycle (Alonso, D. A., Najera, C., Pacheco, M. C., Organic Lett. 2000, 2, 1923).

In another embodiment, and according to scheme 2, the phosphonate moiety is introduced first via procedures outlined for scheme 1 above. Subsequent Heck reaction procedures to form compounds of Formula I are followed by employing an oxime palladacycle as the catalyst (Alonso, D. A., Najera, C., Pacheco, M. C., Organic Lett. 2000, 2, 1923). Similar phospha-catalysts have been described in Herrmann, W. A., Bohm, V. P. W., Reisinger, C. P., J. Organomet. Chem. 1999, 576, 23.

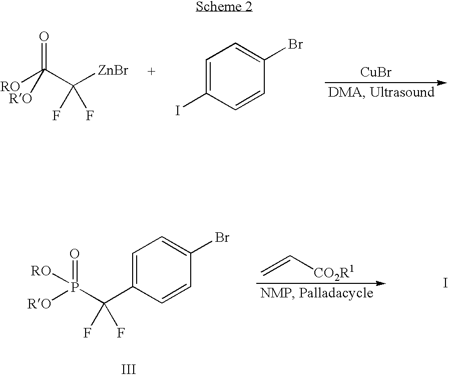

Preferably, the difluoromethylphosphonate of both scheme 1 and scheme 2 is formed according to the procedure found in Yokomatsu, T., Murano, T, Suemune, K, Shibuya, S., Tetrahedron, 1997, 53, 815, and Cockerill, G. S., Easterfield, H. J., Percy, J. M., Tetrahedron Lett., 1999, 40, 2601.

In a preferred embodiment, the method of scheme 1 is utilized.

Scheme 3 depicts a method for the formation of the cinnamate acid derivative Ib by hydrolysis of cinnamate ester derivative Ia with a base. Preferable bases used in this hydrolization step are those with alkali metals or alkaline earth metals such as lithium, sodium, potassium, calcium and magnesium. Even more preferred bases are alkaline metal hydroxides, such as, for example, lithium hydroxide or sodium hyrdroxide. Neutralization must be carried out carefully as to avoid hydrolysis of any of the phosphonate protecting groups.

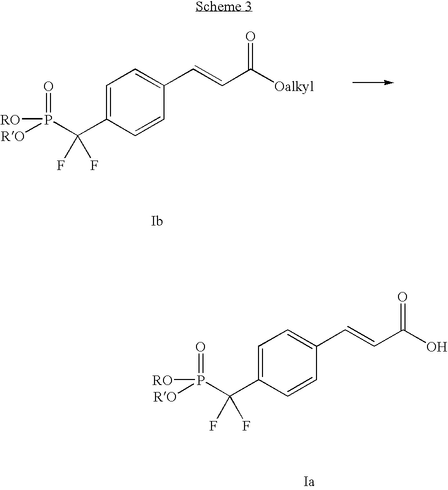

In a preferred embodiment, the reaction of scheme 3 is carried out in one or more solvents selected from a protic solvent and an organic solvent. In a more preferred embodiment, the reaction is carried out in a mixture of a protic solvent and an organic solvent. Even more preferably, the protic solvent is water.

The organozinc reagent is formed by the procedure described in Yokomatsu, T., Murano, T., Umesue, I., Soeda, S., Shimeno, H, Shibuya, S., Bioorg. and Med. Chem. Lett. 1999, 9, 529 and depicted below in scheme 4.

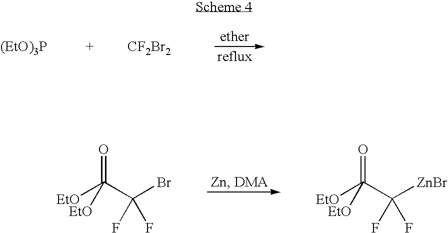

The disclosures in this application of all articles and references, including patents, are incorporated herein by reference.

The invention is illustrated further by the following examples, which are not to be construed as limiting the invention in scope or spirit to the specific procedures described in them.

The starting materials and various intermediates may be obtained from commercial sources, prepared from commercially available organic compounds, or prepared using well known synthetic methods.

Representative examples of methods for preparing intermediates of the invention are set forth below.

### EXAMPLE 1

### Synthesis of Methyl-4-iodocinnamate (1)

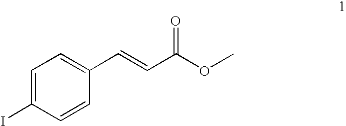

4-Iodoaniline (91 mmol) is dissolved in 37 mL of 48% tetrafluoroboric acid. A solution of sodium nitrite (91 mmol) in 46 mL of water is added and the resulting mixture is heated for 1 hour at 0° C. After 1 hour, methanol (215 mL), methyl acrylate (183 mmol) and palladium acetate (1.1 mmol) are then added sequentially to the mixture, which is then heated at 50° C. for 2 hours. The reaction mixture is allowed to cool to room temperature and concentrated in vacuo. This crude reaction mixture is purified by column chromatography on silica gel (hexane: ethyl acetate 50:1) to give methyl-4-iodocinnamate 1 (17.5g, 84.1%) as a light-yellow solid. This solid could be further purified by recrystallization from chloroform and hexanes. ¹H NMR (CDCl₃): 7.74 (d, J=8 Hz, 2H), 7.62 (d, J=16Hz, 1H), 7.25 (d, J=8.1 Hz, 2H), 6.45(d, J=16Hz, 1H), 3.81(s, 3H); ¹³C NMR (CDCl₃): 162.8, 139.3, 133.8, 129.5, 125.2, 114.2, 92.2, 47.5.

### EXAMPLE 2

### Synthesis of 3-{4-[(Diethoxy-phosphoryl)-difluoro-methyl]-phenyl}-acrylic acid methyl ester (2)

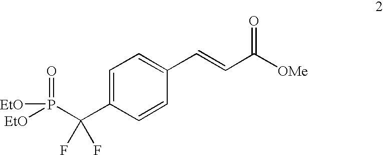

To a stirred suspension of activated zinc dust (70 mmol) in 35 mL dry dimethylacetamide (DMA) is added slowly a solution of diethyl(bromodifluoromethyl)phosphonate (70 mmol) in 35 mL DMA under a nitrogen atmosphere. The reaction mixture is stirred for 1 hour at room temperature, heated to 45° C. for 1 hour and then room temperature for a further hour. Copper bromide (70 mmol) is added and the resulting mixture is stirred for 45 minutes. A suspension of methyl 4-iodocinnamate 1 (35 mmol) in 30 mL DMA is poured into the reaction mixture. The resulting reaction mixture is subjected to sonication for 24 hours under a nitrogen atmosphere. After this period of time, thin layer chromatography indicates that all the starting material has been consumed. The reaction mixture is then partitioned between water and ether. The biphasic mixture is passed through celite and extracted with ether. The organic extracts are washed with brine and dried over sodium sulfate. The volatiles are removed in vacuo, and the residue is chromatographed on silica gel (hexane:ethyl acetate 50:3) to yield the desired cinnamate ester 2 as a light colored solid (75%). ¹H NMR (CDCl₃): 7.67(d, J=16Hz, 1H), 7.61(m, 4H), 6.47(d, J=16Hz, 1H), 4.25(m, 4H), 3.79(s, 3H), 1.32(m, 6H).

### EXAMPLE 3

### Synthesis of 3-[4-(Diethoxy-phosphoryl)-difluoro-methyl]-cinnamic acid (3)

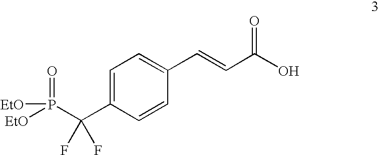

To a stirred solution of 3-{4-[(Diethoxy-phosphoryl)-difluoro-methyl]-phenyl}-acrylic acid methyl ester 2 (6mmol) in 30 mL THF at 0° C. is added 60 mL aqueous lithium hydroxide solution (0.2N) in a dropwise manner, and the reaction is stirred at 0° C. for 3 hours. The reaction mixture is then diluted with 30 mL water and washed with 2×20 mL ethyl acetate. The aqueous phase is cooled to 0° C. and acidified carefully with ice-cold aqueous hydrochloric acid (0.2N) and extracted with 6×30 mL ethyl acetate. The combined organic extracts are washed with 10 mL brine, dried over sodium sulfate, and concentrated in vacuo to give cinnamate acid 3 as a colorless solid (60%). ¹H NMR (CDCl₃): 7.75 (d, J=16 Hz, 1H), 7.63(m, 4H), 6.58 (d, J=16 Hz, 1H), 4.26(m, 4H), 1.35(t, J=7.2 Hz, 6H).

### EXAMPLE 4

### Synthesis of Diethyl(bromodifluoromethyl)phosphonate

Dibromodifluoromethane (209.8 g, 1 mol) is added to a magnetically stirred solution of triethyl phosphite (153.5 g, 0.925 mol) in anhydrous ether (450 ml) under a nitrogen atmosphere. After the addition, the reaction is allowed to warm to room temperature before being refluxed for 20 hours. The volatiles are removed in vacuo, and the product is purified by distillation (b.pt. 50-52° C., 1 mm/Hg) to yield diethyl(bromodifluoromethyl) phosphonate as a colorless liquid (256.3 g, 96%); ¹H NMR (CDCl₃): 4.35 (m, 4H), 1.35 (m, 6H). ¹³C NMR (CDCl₃): 122.9, 119.8, 118.6, 115.4, 114.2, 111.1, 66.59, 66.50, 16.56, 16.48.

The invention and manner and process of making and using it, are now described in such full, clear, concise and exact terms as to enable any person skilled in the art to which it pertains, to make and use the same. It is to be understood that the foregoing describes preferred embodiments of the present invention and that modifications may be made therein without departing from the spirit or scope of the present invention as set forth in the claims. To particularly point out and distinctly claim the subject matter regarded as invention, the following claims conclude this specification.

What is claimed is:

1. A compound of the formula 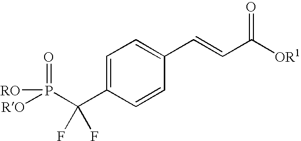
wherein
R¹ is hydrogen or lower alkyl; and
R and R′ are the same and represent hydrogen or a phosphate protecting group.

2. A compound according to claim 1 wherein R¹ is hydrogen or methyl.

3. A compound according to claim 2 wherein R and R′ are ethyl.

4. A compound according to claim 1 which is selected from 3-{4-[(diethoxy-phosphoryl)-difluoro-methyl]-phenyl}-acrylic acid methyl ester and 3-[4-(diethoxy-phosphoryl)-difluoro-methyl]-cinnamic acid.

5. A method of preparing a 4-(disubstituted-oxy-phosphoryl)-difluoro-methyl-cinnamic acid derivative having the formula 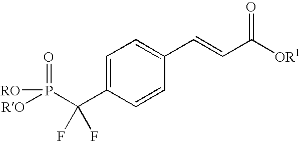
wherein
R¹ is hydrogen or lower alkyl; and
R and R′ are the same and represent hydrogen or a phosphate protecting group. the method comprising
(a) reacting a 4-haloaniline with an acrylic acid derivative under Heck reaction conditions to form a 4-halocinnamic acid derivative; and
(b) reacting the 4-halocinnamic acid derivative with a disubstituted(bromodifluoromethyl)phosphonate organozinc reagent to form the 4-(disubstitutedoxy-phosphoryl)-difluoro-methyl-cinnamic acid derivative.

6. A method according to claim 5 wherein the Heck reaction conditions further comprise
(a) reacting the 4-haloaniline with a metal nitrite and HBF₄ to form the diazonium salt; and
(b) reacting the diazonium salt with the acrylic acid derivative in the presence of a palladium catalyst to form the 4-halocinnamic acid derivative.

7. A method according to claim 6 wherein the metal nitrate is sodium nitrite.

8. A method according to claim 7 wherein the 4-haloaniline is reacted with the sodium nitrite and HBF₄ in an aqueous media.

9. A method according to claim 6 wherein the palladium catalyst is palladium acetate.

10. A method according to claim 5 wherein the 4-(disubstitutedoxy-phosphoryl)-difluoro-methyl-cinnamic acid derivative is hydrolyzed to form a compound where R¹ is hydrogen.

11. A method according to claim 10 wherein the 4-(disubstitutedoxy-phosphoryl)-difluoro-methyl-cinnamic acid derivative is hydrolyzed with a metal hydroxide.

12. The method of claim 11 wherein the metal hydroxide is lithium hydroxide.

13. The method of claim 5 wherein R and R′ are ethyl.

14. The method of claim 6 wherein the 4-haloaniline is reacted with a metal nitrite and HBF₄ at temperatures from between −10° C. to 10° C.

15. The method of claim 14 wherein the diazonium salt is reacted with the acrylic acid derivative in the presence of a palladium catalyst at temperatures of from between 25° C. and 100° C.
